(19) United States
(12) Patent Application Publication
(10) Pub. No.: US 2007/0005679 A1
(43) Pub. Date: Jan. 4, 2007

(54) Server-client hybrid search systems, methods, and apparatuses

(76) Inventors: Richard T. Bui, Houston, TX (US); Charles D. Letterman, Houston, TX (US); Andrew D. Hamilton, Houston, TX (US); Justin C. Prindle, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,260

(22) Filed: Jun. 21, 2005

(51) Int. Cl. G06F 15/16

(52) U.S. Cl. 709/201

(57) ABSTRACT

One embodiment of a method includes the steps of a client subsystem receiving a set of initial search results from a server subsystem, a rule engine initiating a scan of the client subsystem to collect technical information associated with the client subsystem, and the rules engine filtering the set of initial search results at the client subsystem. The filtering step is based on the collected technical information.

### BACKGROUND

Providers of computer-related products (e.g., software programs and hardware devices) often provide technical support to assist customers in installing, operating, troubleshooting, and/or upgrading the products. One common way of providing technical support allows customers to search for and use relevant support content located at a remote repository. For example, customers often use the Internet to access support content made available through a server. Customers typically submit questions and/or keywords to the server, and a server-based application uses the questions and/or keywords to search a repository for relevant support content (e.g., a web page, software upgrade, etc.), which is then provided to the customer.

Unfortunately, many customers are not adept at identifying appropriate questions, keywords, and other information useful for identifying relevant support content. In particular, novice computer users are often unable to answer technical questions about computer products. For example, many novice users may not know how to find the model of their printer or the version of the print driver for the printer. As a result, novice computer users often struggle to provide the appropriate information needed to accurately identify relevant support content. The novice users may become frustrated and may even provide incorrect information.

Because of the problems associated with the technical support techniques described above, providers of computer products have sought to reduce the burden placed on customers by attempting to automatically gather search criteria from customer computers. In particular, customer computers are scanned to determine configuration information (e.g., information indicative of the operating state of a computer). The determined information is sent to a server, where the information is used to search for and identify relevant support content.

Such automated technical support applications have generally eased the burden placed on customers in identifying appropriate search criteria. However, there are several problems and concerns associated with conventional automated technical support applications. One such problem, which may be referred to as a boundary problem, is inherent in automatic technical support applications that are designed to support a wide variety of computer products. The boundary problem refers to difficulties associated with forecasting the type and/or amount of information that should be provided to a server with a search request in order for the server-side technical support service to accurately identify appropriate support content. If the scope of the provided information is too small, the technical support service will struggle to accurately identify support content that is relevant to an actual problem or need associated with a customer's computer. Moreover, under-inclusive search information may produce a large search result space, and the downloading of large amounts of the support content is inefficient.

On the other hand, if the scope of the provided information is too large, efficiency and privacy concerns are introduced. The transmission of large amounts of search information (e.g., an entire operating system registry) to the server is inefficient and would tax the resources of the server. Moreover, customers may prefer that certain information be kept private and not be sent to a remote server for analysis. For example, customers may not want to provide information identifying the programs that are installed on the customer computers.

### BRIEF DESCRIPTION OF THE DRAWINGS

The accompanying drawings illustrate various embodiments of the present systems, methods, and apparatuses and are a part of the specification. The illustrated embodiments are merely examples of the present systems, methods, and apparatuses and do not limit the scope of the disclosure.

FIG. 1 is a high-level block diagram illustrating an example of an implementation of a client-server hybrid search system, according to one embodiment.

FIG. 2 illustrates a detailed block diagram of the client-server hybrid search system of FIG. 1, according to one embodiment.

FIG. 3 is a block diagram illustrating an example of a set of initial search results produced by the client-server hybrid search system of FIG. 1, according to one embodiment.

FIG. 4 is a block diagram illustrating a detailed example of the client subsystem of FIG. 1, according to one embodiment.

FIG. 5 is a flowchart illustrating an example of a method of operation of the client-server hybrid search system of FIG. 1, accordingly to one embodiment.

FIG. 6 is a flowchart illustrating an example of a method of operation of the client subsystem of FIG. 1, according to one embodiment.

Throughout the drawings, identical reference numbers designate similar, but not necessarily identical, elements.

### DETAILED DESCRIPTION

Examples of client-server hybrid search systems, methods, and apparatuses are described herein. According to several embodiments, a client-side subsystem sends a search request and associated search parameters to a server-side subsystem. The search parameters may include adequate information for performing a coarse search function at the server-side subsystem. The server-side subsystem uses the search parameters to search stored data for relevant content, which is retrieved and sent to the client-side subsystem. The relevant content includes predefined rules, which are evaluated by the client-side subsystem to perform a client-side filtering of the content. Evaluation of the rules is based on technical information descriptive of the configuration and/or operational state of the client-side subsystem. The technical information may be automatically gathered by probing the components of the client subsystem. The filtered results can be provided to the client-side application that initiated the search request.

By performing a coarse search at the server side and then filtering the results of the coarse search at the client side, the disclosed systems, methods, and apparatuses provide an accurate, flexible, and efficient search mechanism. Significantly, appropriate amounts of data are efficiently transmitted between the client side and the server side. The systems, methods, and apparatuses can be tailored to transmit efficient levels of data for particular implementations and applications. This allows the amount of data transmitted between the client side and the server side to be reduced without compromising accuracy because the client-side subsystem filters the coarse search results to accurately identify the most relevant content for the particular search request.

In addition, the present systems, methods, and apparatuses are extensible. Additional functionality may easily be added because modular objects are used in many embodiments to implement the systems, methods, and apparatuses. Accordingly, filtering rules may be modified, deleted, or added. Functions that probe (i.e., scan) the client subsystem may also be modified, deleted, or added to easily adjust the technical information that is gathered and used to evaluate the rules. The extensibility of the present systems, methods, and apparatuses will become more apparent upon further reading of the disclosure.

In the following description, for purposes of explanation, numerous specific details are set forth in order to provide a thorough understanding of the present systems, methods, and apparatuses. It will be apparent, however, to one skilled in the art, that the present systems, methods, and apparatuses may be practiced without these specific details. Reference in the specification to “one embodiment” or “an embodiment” means that a particular feature, structure, or characteristic described in connection with the embodiment is included in at least one embodiment. Appearances of the phrase “in one embodiment” in various places in the specification do not necessarily all refer to the same embodiment.

Client-Server Hybrid Search Systems

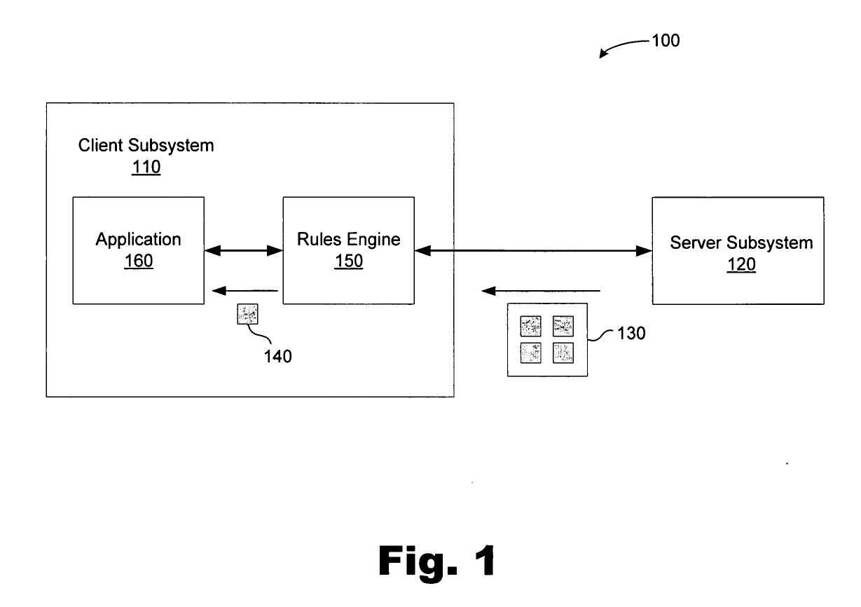

FIG. 1 illustrates, at a high level, an example of a client-server hybrid search system (100), according to one embodiment. As shown in FIG. 1, a client subsystem (110) is communicatively coupled to a server subsystem (120). The client subsystem (110) and the server subsystem (120) may be communicatively coupled by any suitable technology or technologies that support communication of information between the client subsystem (110) and the server subsystem (120). For example, the client subsystem (110) and the server subsystem (120) may communicate over any suitable communication network or networks, including but not limited to, packet-switched networks, local area networks, wide-area networks, metropolitan area networks, home networks, personal networks, campus networks, wireless networks, ad hoc networks, and other types of communications networks and connections. In one embodiment, the client subsystem (110) and the server subsystem (120) are configured to communicate over the Internet. Any suitable communication medium or media (e.g., wireless or transmission line) and protocol(s) may be employed for propagation of communications between the client subsystem (110) and the server subsystem (120).

The server subsystem (120) may include one or more server-side devices, applications, and services that allow the processing of the server subsystem (120) to be performed. The server subsystem (120) may include one or more general purpose computing devices capable of running a wide variety of different software applications or one or more specialized devices designed for particular functions. The devices of the server subsystem (120) may comprise a network of computing devices. The server subsystem (120) may include any type, number, form, or configuration of processors, system memory, computer-readable mediums, peripheral devices, and operating systems.

The server subsystem (120) can include one or more servers of any suitable types. In one embodiment, for example, the server subsystem (120) includes at least one web server. Preferably, the server subsystem (120) is configured to support web services, including the use of web service data formats and protocols (e.g., extensible markup language (“XML”) and simple object access protocol (“SOAP”)) to communicate with the client subsystem (110).

The server subsystem (120) may receive requests from the client subsystem (110) and provide information to the client subsystem (110) in response to the requests. More specifically, the server subsystem (120) is configured to receive search requests from the client subsystem (110), use the search requests to identify relevant information stored at or accessible to the server subsystem (120), and send the identified information to the client subsystem (110).

The received search request generally includes search parameters, which are used by the server subsystem (120) to search for and identify relevant information. The identified information may be referred to as a set of initial search results (130). As used herein, the term “set” refers to a grouping of one or more items. Thus, the set of initial search results (130) includes one or more instances of search results.

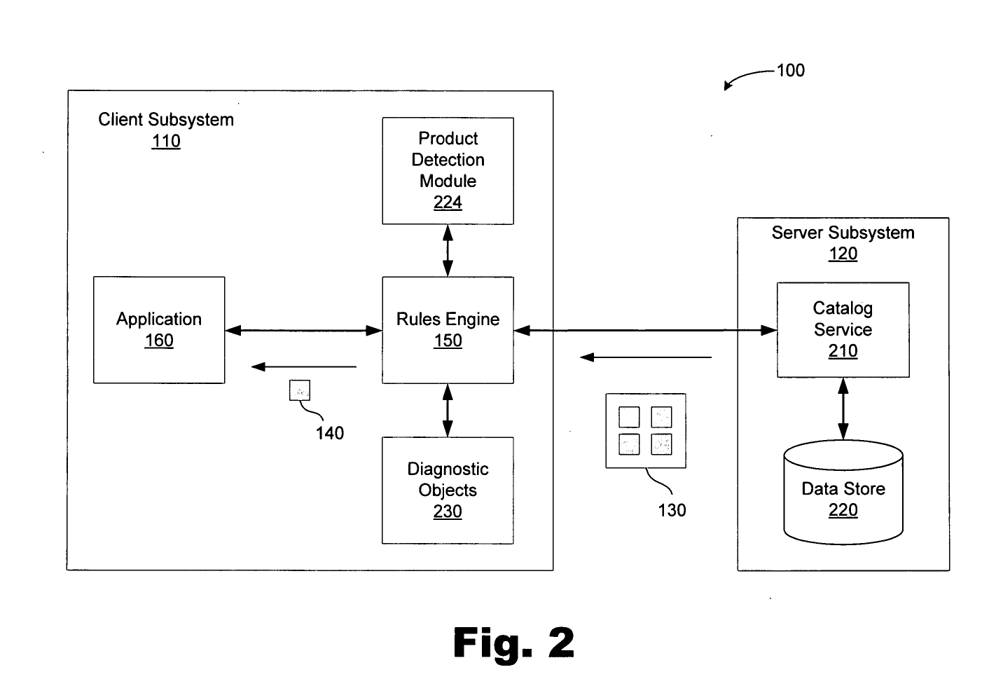

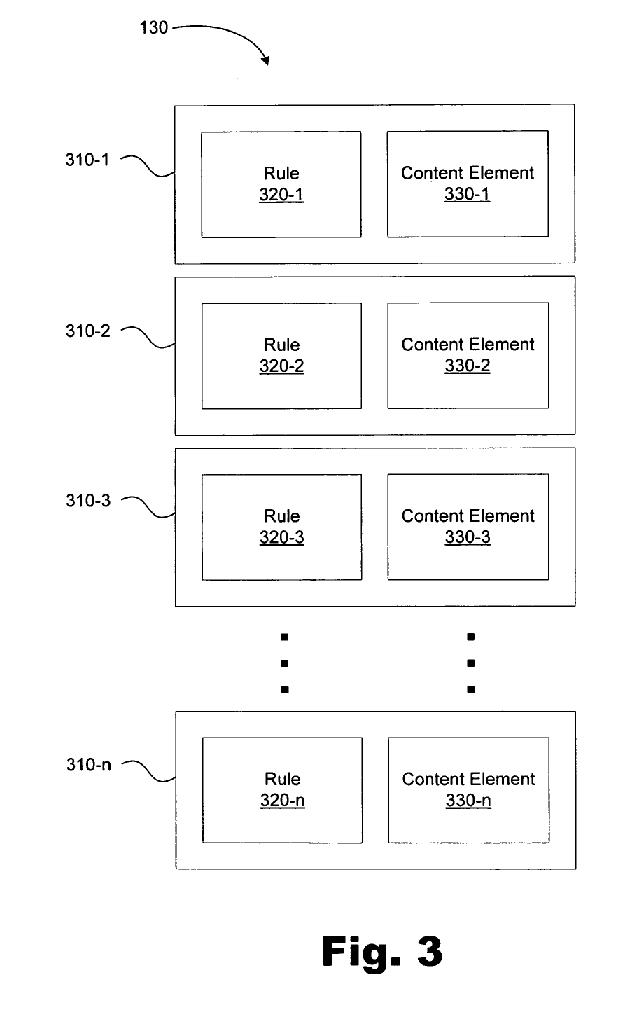

As shown in FIG. 1, the server subsystem (120) sends the set of initial search results (130) to the client subsystem (110). Exemplary components of the server subsystem (120) will be described further below with reference to the embodiment of the system (100) shown in FIG. 2. An example of an embodiment of the set of initial search results (130) will be described below with reference to FIG. 3.

The client subsystem (110) is configured to receive the set of initial search results (130) from the server subsystem (120) and to filter the set of initial search results (130) to generate a set of filtered search results (140). The client subsystem (110) may include one or more client-side devices, applications, objects, modules, engines, processors, memory devices, and interfaces that allow the processing of the client subsystem (110) to be performed. In many embodiments, the client subsystem (110) includes a general purpose computer. However, the client subsystem (110) may include any type of computing device or devices capable of communicating with the server subsystem (200). For example, the client subsystem (130) may include, but is in no way limited to, one or more desktop computers, laptop computers, tablet computers, personal data assistants, cellular telephones, satellite pagers, wireless internet devices, embedded computers, video phones, mainframe computers, mini-computers, workstations, network interface cards, programmable logic devices, entertainment devices, gaming devices, client devices, vehicles, and the like.

In addition, the client subsystem (110) may include various peripherals such as, but not limited to, a terminal, keyboard, mouse, screen, printer, stylus, input device, and output device. The client subsystem (110) may include any applications and tools useful for operating hardware devices (e.g., the peripherals), including drivers for hardware devices.

As shown in FIG. 1, the client subsystem (110) may include a rules engine (150) and an application (160). The application (160) may include any computer program (e.g., software or firmware application) operating on the client subsystem (110). For example, the application (160) may be in the form of a web browser, a hardware driver, a diagnostic application, a technical support application, a software or firmware installation procedure or wizard, a software or firmware upgrade procedure, or any computer program capable of operating on the client subsystem (110).

The rules engine (150) is configured to communicate with the application (160). In particular, the rules engine (150) may receive search requests from and provide search results to the application (160). The rules engine (150) may be implemented in any manner suitable for interfacing with the application (160) and the server subsystem (120), and for performing the filtering processes described herein. For example, the rules engine (150) may comprise one or more COM objects providing COM interfaces for supporting communications with the application (160) and the server subsystem (120). As known to those skilled in the art, COM comprises a Windows® framework for sharing modular objects written in different languages in a seamless fashion. Each COM object publishes an interface which lists properties and methods of the object. Properties might include various bits of data stored in the object, such as the name of the object, and methods can include functions that act upon the data of the object. Other forms of implementation of the rules engine (150) may be used in other embodiments of the system (100).

The rules engine (150) is configured to filter the set of initial search results (130) into the set of filtered search results (140). The set of filtered search results (140) typically includes a subset of the content contained in the set of initial search results (130). To identify the content to be included in the set of filtered search results (140), the rules engine (150) evaluates rules (shown as 320-1 through 320-n in FIG. 3) contained in the set of initial search results (130). The evaluations of the rules take into account technical information that is automatically gathered from components of the client subsystem (110), as discussed below. The automated gathering and use of technical information to filter the set of initial search results (140) effectively reduces errors that are associated with traditional manual search techniques. Examples of both the filtering process and the rules used in the filtering process will be described in detail further below. An embodiment of the rules engine (150) will also be described in greater detail below.

The rules engine (150) may provide the set of filtered search results (140) to the application (160). Typically, the set of filtered search results (140) is provided to the application (160) that initiated the corresponding search request. For example, the application (160) may send a search request to the rules engine (150), which forwards the search request and associated search parameters to the server subsystem (120). The server subsystem (120) functions as described above to produce the set of initial search results (130), and the rules engine (150) functions as described above to generate the set of filtered search results (140). The rules engine (140) then provides the set of filtered search results (140) to the application (160) in response to the search request.

By performing a coarse search at the server subsystem (120) and fine tuning (i.e., filtering) the search at the client subsystem (110), the system (100) is able to provide accurate, flexible, and efficient search capabilities. A large amount of data can be searched on the server side by sending a small amount of search data (e.g., search request and associated search parameters) to the server subsystem (120). A filter function is applied on the client side where abundant search criteria are available. In particular, the client-side filter refines the results produced by the server-side search, based on the automatically gathered technical information associated with components and operations of the client subsystem (110). The system (100) is therefore able to produce accurate search results without having to send large amounts of data (e.g., search parameters) between the client subsystem (110) and the server subsystem (120). This configuration generally uses bandwidth and other resources in an efficient manner by reducing the amount of data transferred between the client subsystem (110) and the server subsystem (120). Moreover, by applying a search filter on the client side, privacy concerns are reduced because only small amounts of data are sent to the server subsystem (120).

Because the system (100) may be implemented on physical computing devices, those skilled in the art will recognize that the various processes described herein may be implemented at least in part as instructions executable by one or more of the computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, an EPROM, a FLASH-EEPROM, any other memory chip or cartridge, or any other medium from which a computer can read.

FIG. 2 illustrates a more detailed block diagram of the client-server hybrid search system (100), according to one embodiment. As shown in FIG. 2, the server subsystem (120) may include a catalog service (210) and a data store (220) in communication with one another. The data store (220) may include one or more storage mediums, devices, or configurations, including databases. The data store (220) can employ any type, form, and combination of storage media known to those skilled in the art. The data store (220) may be integrated with or external of the server subsystem (120) and may include any known technologies useful for storing and accessing information. For example, the data store (220) may include structured query language (“SQL”) technologies, including one or more SQL servers. The data store (220) may include one or more databases, which can be in the form of hierarchical, relational, or other types of databases. The databases may be created and maintained using any known database technologies.

The data store (220) may store data (not shown) representative of support content information. The support content information may include predefined rules and content associated with technical, diagnostic, and/or other types of support services. For example, the content may include, but is not limited to, software downloads, software upgrades, firmware upgrades, fixes, diagnostic tools, help information, troubleshooting information, instructions (e.g., installation instructions), web pages, and any other data that may be helpful for supporting products associated with the client subsystem (110). While this disclosure describes implementations of the system (100) in which hybrid search capabilities are applied to content that is typically associated with technical support applications, the hybrid search capabilities of the system (100) may readily be applied to any other type of information that may be stored in the data store (220).

The predefined rules stored in the data store (220) may include one or more predefined scripts configured to be executed on the client subsystem (110). Specific rules are associated with corresponding content instances. The rules and the content may be defined and maintained by publishers (not shown), which may include human operators of the system (100), or automated applications. The predefined rules and content may be defined to include descriptions of the content (i.e., metadata). The metadata describes conditions that should exist at the client subsystem (110) in order for particular content to be provided or applied. For example, publishers can associate information with the content, including information such as content titles, content descriptions, URL links to content, supported operating systems, supported devices, supported languages, and supported countries. This information may define the conditions to be met to produce a match with specific content instances. Examples of predefined rules and content, as well as their use in filtering the initial search results (130), will be described in detail further below.

The catalog service (210) may include one or more server-side applications configured to provide hosted services to one or more client subsystems (110). The catalog service (210) is configured to receive and process search requests at the server-side of the system (100). The catalog service (210) uses search parameters included with the search request to initiate a search of the data stored in the data store (220). Data relevant to the search parameters is returned to the catalog service (210), which is configured to package the results of the search for transmission to the client subsystem (110). The catalog service (210) may package the results in a catalog referred to as the set of initial search results (130), an example of which will be discussed below with reference to FIG. 3. In one embodiment, the catalog service (210) includes web services capabilities for packaging the search results in a web services compatible format such as XML in SOAP format. Other embodiments may use any suitable data format and protocol for packaging and transmission of the server-side search results to the client subsystem (110).

As mentioned previously, search requests may be sent from the client subsystem (110) to the server subsystem (120). The application (160) may initiate and send a search request to the rules engine (150). The application (160) may or may not provide search parameters along with the search request. If search parameters are provided, the rules engine (150) may simply format the search request and parameters for transmission to the server subsystem (120). Any suitable data format and protocol(s) may be used to transmit the search request to the server subsystem (120). In many embodiments, web services compatible formats and protocols (e.g., XML in SOAP format) are used to transmit the search requests and parameters.

If the application (160) does not provide search parameters with the search request, the rules engine (150) can automatically obtain values for predetermined search parameters. The predetermined parameters may include any technical information descriptive of the configuration or operation of the client subsystem (110). Preferably, the search parameters are of the number and type that can be efficiently transmitted to the server subsystem (120) for use in the server-side coarse searching described above. The predetermined search parameters may include, but are not limited to, data descriptive of the version of operating system(s) running on the client subsystem (110), language and country settings, content-type identifiers, package identifiers, as well as product identifiers. Product identifiers may identify hardware devices, connected peripherals, software applications, firmware applications, and any other product associated with the client subsystem (110).

To obtain values for the predetermined search parameters, the rules engine (150) may interface with a product detection module (224). As shown in FIG. 2, the product detection module (224) may be part of the client subsystem (110). In alternative embodiments, the product detection module (224) may be external to the client subsystem (110). For example, the server subsystem (120) may include a product detection service configured to communicate with the rules engine (150).

The product detection module (224) is configured to scan the client subsystem (110) to detect the operating system(s), language settings, country settings, hardware configuration information, and potentially values for other predetermined information. The product detection module (224) may also be configured to identify products connected to the client subsystem (110), including peripheral devices. Accordingly, the rules engine (150) can instruct the product detection module (224) as to what technical information to gather, and the product detection module (224) can provide the requested technical information to the rules engine (150). The rules engine (150) may then use the technical information as search parameters for one or more search requests, which are forwarded to the server subsystem (120).

The server subsystem (120) may function as described above to process search requests by performing a server-side search of the data store (220) for relevant data and returning search results to the client subsystem (110). By performing a server-side search based on predetermined search parameters, the server subsystem (120) is able to reduce the amount of data that will be downloaded to the client subsystem (110). In FIG. 2, the search results provided to the client subsystem (110) are represented as the set of initial search results (130).

FIG. 3 illustrates an example of the set of initial search results (130), according to one embodiment. As shown in FIG. 3, the set of initial search results (130) may include a catalog of one or more packages (310-1 through 310-n) (collectively “the packages (310)”). Each of the packages (310) can include at least one rule (320-1 through 320-n) (collectively “the rules (320)”) and at least one corresponding content element (330-1 through 330-n) (collectively “the content elements (330)”). The rules (320) and the content elements (330) within common packages (310) are referred to as being associated to one another. Accordingly, the rule (320-1) may be evaluated as described below to determine whether the corresponding content element (330-1) will be selected for insertion in the set of filtered search results (140). As mentioned above, the set of initial search results (130) may be in any suitable data format, including web services compatible formats such as XML in SOAP format.

The content elements (330) may include any of the types of content discussed above, including software downloads, software upgrades, firmware upgrades, fixes, diagnostic tools, help information, troubleshooting information, instructions (e.g., installation instructions), web pages, and any other data that may be helpful for supporting products associated with the client subsystem (110).

The rules (320) may be in the form of predefined scripts that are executable on the client subsystem (110). For example, the scripts may include visual basic scripts (“VBScript”), Java scripts (“Jscript”), Apple scripts (“AppleScript”), and any other type of script that is executable on the client subsystem (110). The rules (320) may be in the form of compiled code. The rules (320) may include or be part of metadata that is descriptive of the content elements (330). The rules (320) may be encoded and/or signed for security purposes.

An evaluation of each of the rules (320) (i.e., an execution of the script) may be configured to produce a “true” or a “false” result, a relevancy score, or some other result. The result may be compared with a predetermined evaluation result (e.g., “true”) to determine whether the evaluation of a particular rule (320) identifies relevant content. Accordingly, the result of the evaluations of the rules (320) may be used to filter the set of initial search results (130) into the set of filtered search results (140).

Returning now to FIG. 2, once the client subsystem (110) receives the set of initial search results (130) from the server subsystem (120), the rules engine (150) may evaluate the rules (i.e., execute the scripts) on the client side to determine the relevancy of the content elements (330) to a search request, thereby effectively performing a client-side filtering function on the content elements (330) contained in the set of initial search results (130). This determination is based on technical information associated with and automatically gathered from the client subsystem (110).

The rules engine (150) is configured to initiate a probe (i.e., a scan) of the client subsystem (110) to gather technical information associated with components of the client subsystem (110). In FIG. 2, the client subsystem (110) is shown to include one or more diagnostic objects (230) in communication with the rules engine (150). The rules engine (150) can retrieve technical information from the client subsystem (110) using the diagnostic objects (230), which are capable of retrieving the technical information from the components of the client subsystem (110). Examples of technical information that may be retrieved by the diagnostic objects (230) include, but are not limited to, information from operating system registries, information about files (e.g., version, date, size, content, etc.), information about hardware devices (including connected peripheral devices), firmware information, software information, and any other technical information descriptive of the operating status and/or configuration of the client subsystem (110).

The diagnostic objects (230) comprise a toolbox of procedures capable of collecting technical information from the client subsystem (110). The diagnostic objects (110) may be in the form of COM objects that can be referenced by scripts (e.g., Jscript and VBScript). As mentioned above, COM comprises a Windows® framework for sharing modular objects written in different languages in a seamless fashion. The diagnostic objects (230) may be categorized into a group of core objects and a group of other objects.

Examples of diagnostic objects (230) include a system information object, an operating system object, a system board information object, a logical drives object, a registry utility object, a file utility object, a spooler object, an initialization file utility object, a driver object, a logical memory object, a process object, a printer object, and any other type of object for determining information descriptive of the condition and/or configuration of the client subsystem (110). Each of the diagnostic objects (230) is configured to determine particular information about the client subsystem (110). For example, the spooler object is able to use operation system spooler application program interface (“API”) calls to collect information about peripherals attached to a device of the client subsystem (110). By way of another example, the registry utility object can collect information from a registry of the client subsystem (110).

The diagnostic objects (230) are extensible. In particular, new diagnostic objects (230) may be easily developed and added to existing diagnostic objects (230). This allows operators of the system (100) to define routines for collecting any desired technical information from the components of the client subsystem (110), including device specific information. Publishers may extensibly define rules (320) designed to initiate calls to any available diagnostic objects (230) to obtain technical information useful in evaluations of the rules (320). The rules engine (150) may also be configured to automatically discover and use available diagnostic objects (230). The extensibility of the system (100) allows it to be easily customized or otherwise adapted for particular applications.

The technical information gathered by the diagnostic objects (230) is sent to the rules engine (150), which uses the technical information to evaluate the rules (320). More specifically, according to one exemplary embodiment, the rules engine (150) is configured to evaluate the rules (320) by comparing the technical information against values and conditions contained in the predefined rules (320). As mentioned above, an evaluation of each of the rules (320) may be configured to produce either a “true” or a “false” result. For rules (320) that evaluate to “true” the rules engine (150) provides the corresponding content elements (330) to the application (160) in response to the associated search request. In other embodiments, the rules (320) may be configured to evaluate to a relevancy score, and one or more of the content elements (330) corresponding with the rules (320) that evaluate to relatively higher relevancy scores are provided to the application (160). The content elements (330) provided to the application (160) are represented as the set of filtered search results (140) in FIG. 2.

The application (160) may present the received content elements (330) for consideration by the user of the client subsystem (110). The application (160) may use the received content elements (330) in other ways, depending on the substance of the content elements (330). For example, content elements (330) in the form of software and firmware downloads, upgrades, and fixes may be installed or executed on the client subsystem (110).

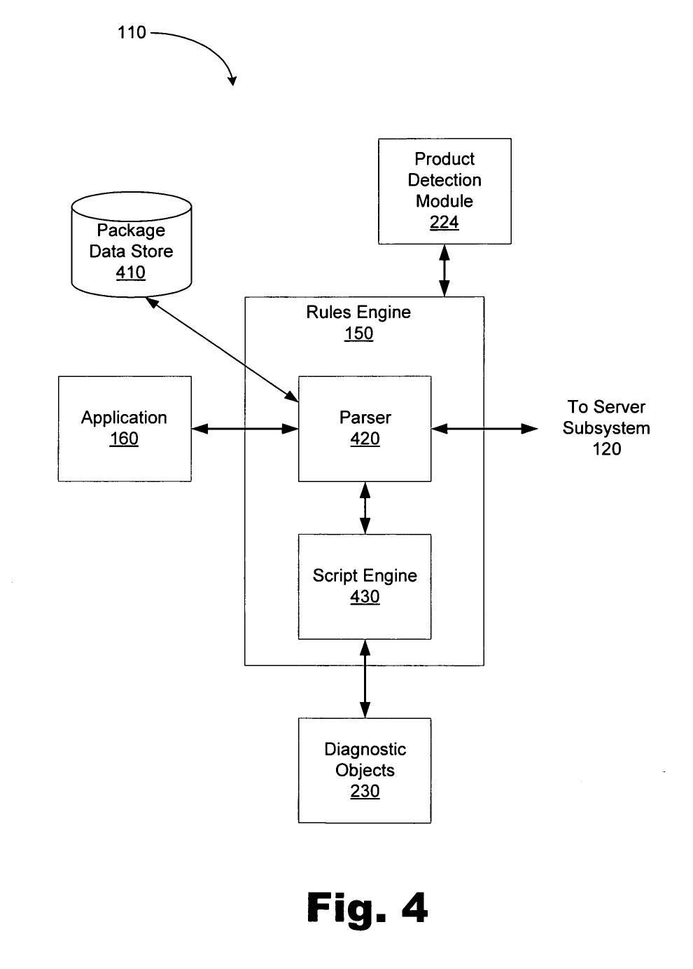

FIG. 4 is a block diagram illustrating a detailed example of the client subsystem (110) of FIG. 1, according to one embodiment. As shown in FIG. 4, the client subsystem (110) may include a package data store (410) in communication with the rules engine (150), which may include a parser (420) and at least one script engine (430). The parser (420) is configured to put search requests into a format suitable for transmission (e.g., XML wrapped in SOAP) to the server subsystem (120) and to parse the set of initial search results (130) received from the server subsystem (120). The parser (420) may be in the form of an XML parser.

Packages (310) contained in the set of initial search results (130) may be stored in the package data store (410). The rules engine (150) may be configured to update the package data store (410) with packages (310) received from the service subsystem (120).

The package data store (410) may include one or more storage mediums, devices, or configurations, including databases. The package data store (410) can employ any type, form, and combination of storage media known to those skilled in the art. The package data store (410) may be integrated with or external of the client subsystem (110) and may include any known technologies useful for storing and accessing information. For example, the package data store (410) may include structured query language (“SQL”) technologies, including one or more SQL servers. The package data store (410) may include one or more databases, which can be in the form of hierarchical, relational, or other types of databases. The databases may be created and maintained using any known database technologies.

When the client subsystem (110) is not in communication with the server subsystem (120) (e.g., the client subsystem (110) is offline), data stored in the package data store (410) may be used to fulfill the coarse search function that is normally performed at the server subsystem (120). In other words, under offline circumstances, the package data store (410) may be used as a backup to the data store (220) at the server subsystem (120). The package data store (410) can identify and return relevant data to the rules engine (150), which data may then be filtered by the rules engine (150) as described above.

The parser (420) parses the set of initial search results (130), which is typically received from the server subsystem (120) but may be received from the package data store (410) under offline conditions. The parser (420) is configured to iteratively consider each package (310) in the set of initial search results (130) and extract the rule (320) contained in the package (310). The rules engine (150) instantiates the script engine (430), which evaluates the rule (320) by executing the script or scripts contained in the rule (320). The script engine (430) issues calls to the diagnostic objects (230) for technical information and uses the technical information returned by the diagnostic objects (230) to evaluate the rule (320). If the rule (320) evaluates to a “true” value, the rules engine (150) will use the content (330) of the package (310) to build a content object. Each content object may be inserted into the set of filtered search results (140) and transmitted to the application (160).

The implementations of the system (100) shown in FIGS. 1-4 are exemplary only and may be modified or changed as may best serve a particular application. In particular, other hardware implementations can be used in alternative embodiments. For example, while FIGS. 1 and 2 show a single server subsystem (120) and a single client subsystem (110), other embodiments may include one or more server subsystems (120) configured to provide hosted services to multiple client subsystems (110). Further, alternative embodiments of the server subsystem (120) can include applications in addition to the catalog service (210). For example, the server subsystem (120) may include a hosted product detection service (not shown) capable of remotely probing for and detecting product, configuration, and other technical information associated with the client subsystem (110). By way of a further example, the server subsystem (120) may include a search request service configured to receive search requests directly from the application (160) of the client subsystem (110), thereby allowing the application (160) to bypass the rules engine (150) for the submission of search requests to the server subsystem (120). In yet another embodiment, the server subsystem (120) may include search metrics (not shown), which quantitatively store data contained in search requests processed and initial search results produced at the server subsystem (120). The data stored in the search metrics provides historical information that may be used to improve the accuracy of the coarse search functions performed at the server subsystem (120). The metrics may include information descriptive of search parameters, including, but not limited to, operating system information, language settings, country settings, product identifiers, package identifiers, and content types. The metrics may further include any data that is part of the set of initial search results (130).

Client-Server Hybrid Search Methods

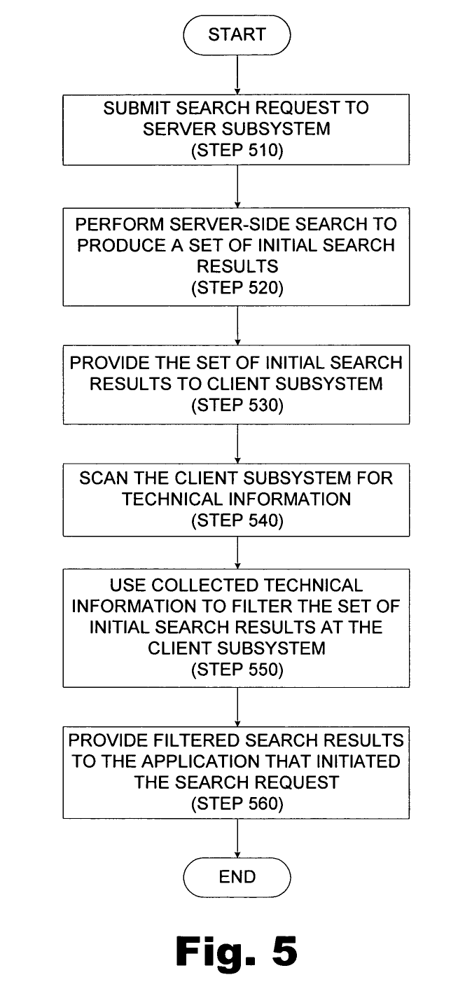

FIG. 5 is a flowchart illustrating an example of a method of operation of the client-server search system (100) of FIG. 1, accordingly to one embodiment. While FIG. 5 shows a number of steps of one method, in other embodiments, some of the steps may be omitted, additional steps may be performed, and/or the steps may be performed in a different order than shown.

The method begins by submitting a search request to the server subsystem (step 510). This step may be performed in any of the ways described above. In one exemplary embodiment, the client subsystem (110; FIG. 1) transmits data representative of the search request to the server subsystem (120; FIG. 1).

A server-side search is performed to produce the set of initial search results (step 520). This step may be performed in any of the ways described above, including, for example, performing a search of the data store (220; FIG. 2) to identify data relevant to search parameters of the search request.

The set of initial search results (130; FIG. 1) is provided to the client subsystem (step 530). This step may be performed in any of the ways described above, including the catalog service (210; FIG. 2) transmitting the set of initial search results (130; FIG. 1) to the client subsystem (110) in any suitable format.

The client subsystem (110; FIG. 1) is scanned for technical information associated with the client subsystem (step 540). This step may be performed in any of the ways described above. For example, the diagnostic objects (230; FIG. 2) may be employed to automatically probe for and obtain technical information associated with the components of the client subsystem (110; FIG. 1). Particular diagnostic objects (230; FIG. 2) may be called in accordance with instructions contained in the predefined rules (320; FIG. 3) and executed by the rules engine (150; FIG. 1).

The collected technical information is used to filter the set of initial search results (130; FIG. 1) at the client subsystem (step 550). This step may be performed in any of the ways described above. For example, the diagnostic objects (230; FIG. 2) may provide the collected technical information to the rules engine (150; Figure), which uses the technical information to evaluate predefined rules (320; FIG. 3). As described above, the evaluation may include execution of scripts, which execution calls for and takes into account technical information associated with the client subsystem (110). The results of the evaluations of the rules (320; FIG. 3) may be used to filter the set of initial search results (130; FIG. 1) into the set of filtered search results (140; FIG. 1).

The filtered search results are provided to the application (160; FIG. 1) that initiated the search request (step 560). This step may be performed as described above and may be performed differently depending on the type of content contained in the filtered search results. For example, technical help instructions may be provided to the application (160; FIG. 1), which in turn can present the help instructions for consideration by a user of the client subsystem (110; FIG. 1). Alternatively, software downloads and upgrades may be installed, or saved on the client subsystem (110; FIG. 1) for later installation.

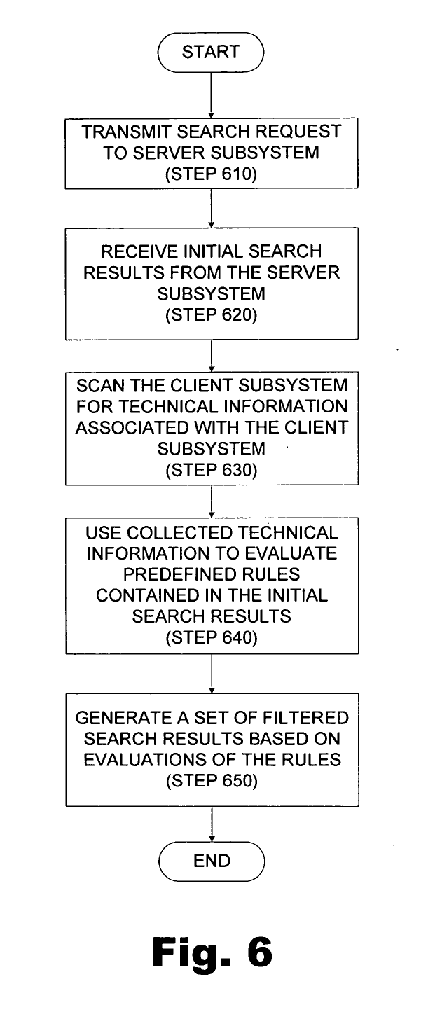

FIG. 6 is a flowchart illustrating an example of a method of operation of from the perspective of the client subsystem (110) of FIG. 1, according to one embodiment. While FIG. 6 shows a number of steps of one method, in other embodiments, some of the steps may be omitted, additional steps may be performed, and/or the steps may be performed in a different order than shown. The method begins by submitting a search request to the server subsystem (step 610). This step may be performed in any of the ways described above. In one embodiment, the client subsystem (110; FIG. 1) transmits data representative of the search request to the server subsystem (120; FIG. 1). Search parameters are typically included with the search request.

In response to the search request, the client subsystem (110; FIG. 1) receives initial search results from the server subsystem (120; FIG. 1) (step 620). The server subsystem (120; FIG. 1) may operate as described above to identify, format, and transmit the initial search results to the client subsystem (110; FIG. 1).

The client subsystem (110; FIG. 1) is scanned for at least a subset of its technical information (step 630). This step may be performed in any of the ways described above. For example, the diagnostic objects (230; FIG. 2) may be employed to automatically probe for and obtain technical information associated with the components of the client subsystem (110; FIG. 1). Particular diagnostic objects (230; FIG. 2) may be called in accordance with information contained in the initial search instructions (e.g., the predefined rules (320; FIG. 3)) and executed by the rules engine (150; FIG. 1).

The collected technical information is used to evaluate the predefined rules (320; FIG. 3) contained in the initial search results (step 640). This step may be performed at the client subsystem (110; FIG. 1) in any of the ways described above. For example, the diagnostic objects (230; FIG. 2) may provide the collected technical information to the rules engine (150; Figure), which uses the technical information to evaluate the predefined rules (320; FIG. 3). As described above, the evaluation may include execution of scripts, which execution calls for and takes into account the collected technical information associated with the client subsystem (110).

A set of filtered search results (140; FIG. 1) is generated based on the evaluations of the predefined rules (step 650). This step may be performed in any of the ways described above, including identifying content elements (330; FIG. 3) having corresponding rules (320; FIG. 3) that evaluate to “true.” The identified content elements (330; FIG. 3) may be inserted into the set of filtered search results (140; FIG. 1).

In conclusion, client-server hybrid search systems, methods, and apparatuses are provided. The present systems, methods, and apparatuses provide an efficient search mechanism that does not compromise accuracy. Search requests may be submitted to a server subsystem, which performs a server-side search to produce initial search results. The server-side search functions as an initial search capable of being performed with minimal search parameters. The server subsystem provides the initial search results to a client subsystem, which filters the initial search results by evaluating predefined rules contained in the initial search results. The client-side filtering is based on technical information associated with the client subsystem and identifies at least of subset of the initial search results that are relevant to the detected configuration and/or operation of the client subsystem. For example, the client subsystem can detect a particular driver running on the client subsystem and pinpoint which content of the initial search results is relevant for that driver. The filtered search results may be provided to an application for appropriate use.

For the user of the client subsystem, the present systems, methods, and apparatuses will help to reduce confusion in providing appropriate search parameters useful for locating relevant support content. Users will not have to manually provide technical information that often leads to mistakes. Service costs may be reduced, because users will be less likely to telephone customer support to fix mistakes.

In addition, the client-server hybrid search systems, methods, and apparatuses transmit only an appropriate and efficient amount of information between client side and server side. The amount of data transmitted to the server side along with search requests is reduced because the server-side search is a coarse initial search. Accuracy is not compromised because client-side filtering can use vast amounts of technical information associated with client-side products to filter the initial search results, without having to transmit additional data to the server side.

The present systems, methods, and apparatuses support a wide variety of applications and implementations, including technical and diagnostic support applications. By way of a specific example, a user of a client device may utilize the present systems, methods, and apparatuses to search for a driver for a specific product (e.g., a printer). The user may access a web-enabled application using the present systems, methods, and apparatuses. A server-side database may be automatically searched for possible drivers, and a catalog of possible matches may be generated. The client device is scanned for technical information (e.g., settings, configurations, etc.), which is used to filter the catalog to identify an appropriate driver.

The preceding description has been presented only to illustrate and describe the present systems, methods, and apparatuses. It is not intended to be exhaustive or to limit the disclosure to any precise form disclosed. Many modifications and variations are possible in light of the above teaching. It is intended that the scope of the disclosure be defined by the following claims.

What is claimed is:

1. A method comprising:
a client subsystem receiving a set of initial search results from a server subsystem;
a rules engine initiating a scan of the client subsystem to collect technical information associated with the client subsystem; and
the rules engine filtering the set of initial search results at the client subsystem, said filtering step being based on the collected technical information.

2. The method of claim 1, wherein the initial search results include a plurality of predefined rules, and said filtering step includes the steps of:
the rules engine evaluating the plurality of predefined rules, said evaluating step being based on the collected technical information; and
the rules engine generating a set of filtered search results based on the evaluations of the plurality of predefined rules.

3. The method of claim 2, wherein said generating step includes the steps of:
the rules engine selecting at least a subset of content contained in the initial search results, the selected content being associated with the predefined rules which render predetermined evaluation results; and
the rules engine inserting the selected content into the set of filtered search results.

4. The method of claim 1, further comprising:
the rules engine receiving the search request from an application;
a product detection module probing the client subsystem to detect values for predetermined search parameters; and
the rules engine submitting the search request, the values, and the predetermined search parameters to the server subsystem.

5. The method of claim 4, wherein said probing step includes automatically detecting at least one of an operating system identifier, a language setting, a country setting, and a product identifier associated with a component of the client subsystem.

6. The method of claim 1, wherein said scanning step includes determining the technical information associated with at least one of a peripheral device, a registry, a file, a firmware program, and a software program.

7. The method of claim 1, further comprising:
a service performing a search of a data store at the server subsystem to identify content relevant to the search request; and
the service generating the set of initial search results to include the identified content.

8. A processor-readable medium having instructions thereon for instructing a processor to perform the steps of:
receiving a set of initial search results from a server subsystem;
scanning a client subsystem to collect technical information associated with the client subsystem; and
using the collected technical information to filter the set of initial search results, the filtering being performed at the client subsystem.

9. The processor-readable medium of claim 8, wherein the initial search results include a plurality of predefined rules, and said step of using the collected technical information to filter the set of initial search results includes the steps of:
evaluating the plurality of predefined rules, said evaluating step being based on the collected technical information; and
generating a set of filtered search results based on the evaluations of the plurality of predefined rules.

10. The processor-readable medium of claim 9, wherein said generating step includes the steps of:
selecting at least a subset of content contained in the initial search results, the selected content being associated with the predefined rules which render predetermined evaluation results; and
inserting the selected content into the set of filtered search results.

11. The processor-readable medium of claim 8, wherein the instructions are further configured to instruct the processor to perform the steps of:
receiving a search request from an application;
probing the client subsystem to detect values for predetermined search parameters; and
submitting the search request, the values, and the predetermined search parameters to the server subsystem.

12. The processor-readable medium of claim 11, wherein said probing step includes automatically detecting at least one of an operating system identifier, a language setting, a country setting, and a product identifier associated with a component of the client subsystem.

13. The processor-readable medium of claim 8, wherein said scanning step includes determining the technical information associated with at least one of a peripheral device, a registry, a file, a firmware program, and a software program.

14. A system, comprising:
a server subsystem;
a client subsystem in communication with said server subsystem;
a set of initial search results generated at said server subsystem and delivered to said client subsystem; and
a set of filtered search results generated by filtering said set of initial search results at said client subsystem, said filtering being performed based on technical information detected by scanning said client subsystem.

15. The system of claim 14, wherein said set of initial search results includes at least one predefined rule and at least one content element associated with said at least one predefined rule.

16. The system of claim 15, wherein said set of filtered search results includes at least a subset of said at least one content element contained in said initial search results.

17. The system of claim 15, wherein said client subsystem includes a rules engine configured to evaluate said at least one predefined rule based on said technical information.

18. The system of claim 15, wherein inclusion of said at least one content element in said set of filtered search results is based on an evaluation of said at least one predefined rule associated with said at least one content element.

19. The system of claim 14, wherein said client subsystem includes at least one extensible diagnostic object configured to perform an automatic probe of said client subsystem for said technical information.

20. The system of claim 14, wherein said client subsystem includes a product detection module configured to probe said client subsystem to detect at least one search parameter, said search parameter including at least one of an operating system identifier, a language setting, a country setting, and a product identifier.
